(19) United States
(12) Patent Application Publication
(10) Pub. No.: US 2024/0150978 A1
(43) Pub. Date: May 9, 2024

(54) INFORMATION MANAGEMENT DEVICE, INFORMATION MANAGEMENT METHOD, AND STORAGE MEDIUM

(71) Applicant: NEC Corporation, Minato-ku, Tokyo (JP)

(72) Inventors: Chisato Sugawara, Tokyo (JP); Nana Jumonji, Tokyo (JP); Yosuke Kimura, Tokyo (JP); Malko Hasegawa, Tokyo (JP)

(73) Assignee: NEC Corporation, Minato-ku, Tokyo (JP)

(21) Appl. No.: 18/281,166

(22) PCT Filed: Mar. 15, 2021
(86) PCT No.: PCT/JP2021/010370

§ 371 Date: Sep. 8, 2023

(51) Int. Cl. E01C 23/01; G06F 16/9032; G06F 16/9038; G06F 16/909

(52) U.S. Cl. CPC E01C 23/01; G06F 16/9032; G06F 16/9038; G06F 16/909

(57) ABSTRACT

An information management device according includes a storage unit, a search processing unit, and a display processing unit. The storage unit stores report information in which report content indicating the condition of road deterioration is associated with location information, which includes at least one of a deterioration occurrence location indicating a location identified for a deterioration occurrence, and a deterioration occurrence area indicating a prescribed area. The search processing unit searches, from the storage unit, report information in which the location information is included in a search area indicating a prescribed area being searched. The display processing unit outputs the search results.

### TECHNICAL FIELD

The present disclosure relates to an information management device or the like that manages reports of road deterioration.

### BACKGROUND ART

Local governments receive information (complaints) about deterioration states of roads from road users such as residents every day, and persons in charge deal with several thousands to several tens of thousands of pieces of information per year. Reports from road users such as residents include information on highly urgent deterioration (pot holes, etc.), and information that cannot be covered by patrols for investigating road deterioration may include in some cases.

PTL 1 discloses a management system that receives complaints about roads and road facilities, determines countermeasures, and records results of the countermeasures.

### CITATION LIST

### Patent Literatures

PTL 1: JP 2004-220586 A
PTL 2: JP 2007-141212 A

### SUMMARY OF INVENTION

### Technical Problem

In a report on the deterioration state of a road from a road user such as a resident, the occurrence position of the deterioration is ambiguously described in general. Therefore, the person in charge who has received the report studies which position on the map to register the deterioration, in consideration of the quantity and quality of complaints, date and time, and the like for each reported occurrence position.

An object of the present disclosure is to provide an information management device or the like that efficiently manages reports on road deterioration from road users such as residents in road deterioration management.

### Solution to Problem

An aspect of an information management device according to the present disclosure includes a storage unit that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area, a search processing unit that searches the storage unit for report information in which the position information is included in a search range indicating a predetermined range to be searched, and a display processing means that outputs a search result.

An aspect of an information management method according to the present disclosure includes searching a storage means that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area, for report information in which the position information is included in a search range indicating a predetermined range to be searched, and outputting a search result.

An aspect of a program stored in a storage medium according to the present disclosure causes a computer to execute searching a storage means that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area, for report information in which the position information is included in a search range indicating a predetermined range to be searched, and outputting a search result.

The program may be stored in a non-transitory storage medium readable and writable by a computer.

### Advantageous Effects of Invention

According to the information management device of the present disclosure, it is possible to efficiently manage reports on road deterioration from road users such as residents in road deterioration management.

### BRIEF DESCRIPTION OF DRAWINGS

FIG. 1 is a diagram illustrating an outline of an information management system according to a first example embodiment.

FIG. 2 is a block diagram illustrating an example of a configuration of an information management device according to the first example embodiment.

FIG. 3 is a diagram illustrating an example of report information stored in a report information storage unit.

FIG. 4 is a diagram illustrating an example of deterioration information stored in a deterioration information storage unit.

FIG. 5 is a flowchart illustrating operations in search processing.

FIG. 6 is a diagram illustrating an example of setting a search range near Px.

FIG. 7 is a diagram illustrating an example of a search range of Px and positions of existing report information.

FIG. 8 is a diagram illustrating an example of search results obtained by searching in response to reports on Px.

FIG. 9 is a flowchart illustrating an example of operations in registration processing.

FIG. 10 is a diagram illustrating an example of setting a search range near P4.

FIG. 11 is a diagram illustrating an example of a search range of P4 and positions of existing report information.

FIG. 12 is a diagram illustrating an example of registration results obtained by registering reports on P4.

FIG. 13 is a flowchart illustrating an example of operations in update processing.

FIG. 14 is a view illustrating a confirmed position of P100.

FIG. 15 is a diagram illustrating an example of a search position of P100 and positions of existing report information.

FIG. 16 is a flowchart illustrating another example of operations in registration processing.

FIG. 17 is a diagram illustrating an example of a search range of P5 and a position of existing report information.

FIG. 18 is a diagram illustrating an example of results of registration of reports on P5.

FIG. 19 is a flowchart illustrating another example of operations in search processing.

FIG. 20 is a diagram illustrating an example of setting a search range near Px.

FIG. 21 is a diagram illustrating an example of a search range of Px and a position of existing report information and deterioration information.

FIG. 22 is a diagram illustrating an example of search results obtained by searching the existing report information and deterioration information.

FIG. 23 is a block diagram illustrating an example of a configuration of an information management device according to a second example embodiment.

FIG. 24 is a flowchart illustrating operations in search processing.

FIG. 25 is a diagram illustrating an example of a hardware configuration of a computer.

### EXAMPLE EMBODIMENT

Examples in which information management devices according to example embodiments of the present disclosure are applied to road deterioration management will be described. The information management devices described below manage complaints on road deterioration from road users such as residents as report information including items of report contents and position information. A part of the position information on the reported road deterioration is registered using a deterioration occurrence range indicating the approximate occurrence position of the road deterioration.

The information management devices can search for position information including a deterioration occurrence range indicating an approximate deterioration occurrence position, and can search for report information managed by specifying the deterioration occurrence range. When the position of road deterioration is identified by on-site confirmation or the like, the information management devices can update the position information of the report information. For example, the information management devices update a deterioration occurrence range indicating an approximate occurrence range of deterioration to a deterioration occurrence position indicating a specified position of occurrence of deterioration.

### First Example Embodiment

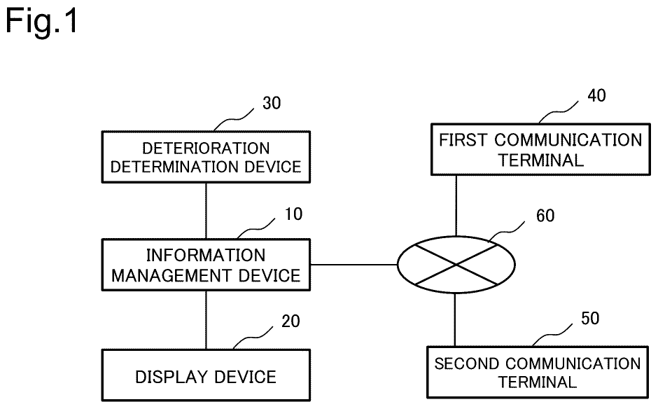

An information management system of a first example embodiment will be described with reference to the drawings. FIG. 1 is a diagram illustrating an outline of the information management system according to the first example embodiment. In the information management system, an information management device 10 is connected to a display device 20 and a deterioration determination device 30. The display device 20 displays the information output from the information management device 10. The display device 20 is a liquid crystal monitor, for example. The deterioration determination device 30 is a device that determines the deterioration state of a road based on sensor information. The sensor information includes image information captured by a drive recorder mounted in a vehicle and acceleration information acquired by an acceleration sensor, for example.

The information management device 10 is communicably connected to a first communication terminal 40 and a second communication terminal 50 via a network 60. The first communication terminal 40 is a communication terminal that is used by a person in charge of inspecting roads (hereinafter, referred to as a person in charge of inspection). The second communication terminal 50 is a communication terminal that is used by road users such as residents when reporting road deterioration. The first communication terminal 40 and the second communication terminal 50 are smartphones, for example.

The information management device 10 may be a client server. In this case, the display device 20 is connected to a client terminal (not illustrated). The client terminal accesses the information management device 10 via the network 60.

(Information Management Device)

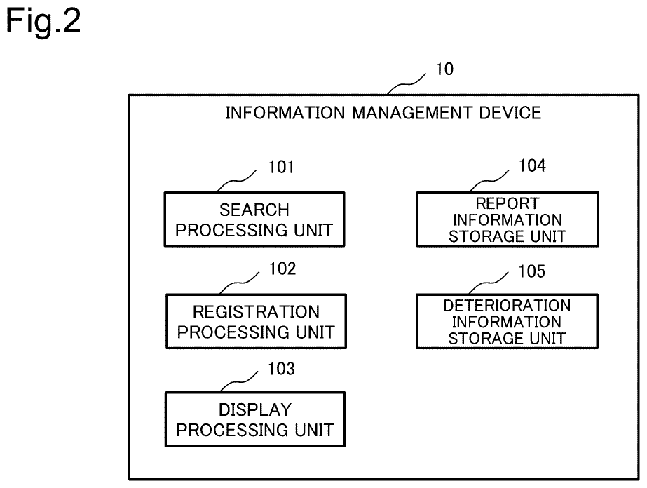

Hereinafter, the information management device 10 will be described with reference to the drawings. FIG. 2 is a block diagram illustrating a configuration example of the information management device 10 according to the first example embodiment. The information management device 10 illustrated in FIG. 2 includes a search processing unit 101, a registration processing unit 102, a display processing unit 103, a report information storage unit 104, and a deterioration information storage unit 105. The report information storage unit 104 and the deterioration information storage unit 105 will be also simply referred to as storage units. The information management device 10 includes a communication unit (not illustrated) connected to the network 60.

(Search Processing Unit 101)

The search processing unit 101 receives information indicating a search range, and searches for report information related to position information of the received search range from the report information storage unit 104 that stores the report information in which the report content and the position information are associated with each other. The search processing unit 101 may search for the report information in which the position information is included in the search position from the storage means.

The search range is represented by position information of a rough range (region) used for searching. As the search range, for example, a region is designated by a circle or a rectangle, and the size of the circle or the rectangle can be arbitrarily set. The search position is a specific position as a search target.

The position information associated with the report content indicates a rough range of the occurrence position of road deterioration based on the report from a road user such as a resident. The range will be referred to as a deterioration occurrence range or a predetermined range. The position information includes the above-described deterioration occurrence position or deterioration occurrence range (predetermined range). The deterioration occurrence position may be position information using base station positioning or global positioning system (GPS) positioning, or may be a position information at a distance from a reference point in a road section, for example.

On the other hand, the deterioration occurrence range is indicated by a range that is separated by a predetermined distance from a temporary position corresponding to the occurrence position of road deterioration reported from a road user such as a resident, for example. The deterioration occurrence range indicates a range within a radius of 100 m from a temporary position P0, for example. The predetermined distance is not limited to 100 m. For example, the predetermined distance can be arbitrarily set according to the details of the occurrence position reported from a road user such as a resident. When the occurrence position of road deterioration is specified by confirmation work or the like, the deterioration occurrence range is updated to the above-described deterioration occurrence position by update processing described later.

The search processing unit 101 may search for the deterioration information related to the received position information of the search range from the deterioration information storage unit 105 that stores the deterioration information in which the deterioration contents and the position information of the road are associated with each other.

(Registration Processing Unit 102) The registration processing unit 102 registers report information indicating reports of road deterioration from a road user such as a resident in the report information storage unit 104. Specifically, the registration processing unit 102 generates report information in which the report contents indicating the deterioration state of the road is associated with the position information including the deterioration occurrence position indicating the specified position about the occurrence of the deterioration or the deterioration occurrence range indicating the predetermined range, in response to the input from a user, and registers the report information in the report information storage unit 104. The user is a road user such as a manager or a resident, for example.

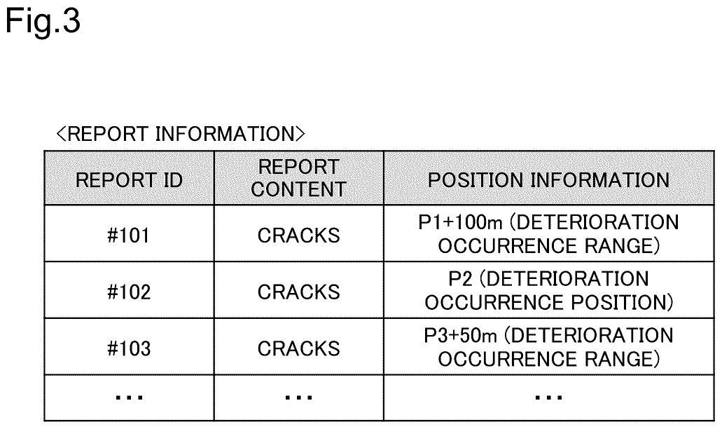

FIG. 3 is a diagram illustrating an example of report information. In the report information, report ID, report content, and position information are stored in association with each other. The report information is not limited to the items in FIG. 3, and may include other items. The report ID is an identifier of the report information. The report content is a content related to road deterioration reported from road users such as residents. The report content is a crack or a pot hole, for example. The report content is not limited thereto, and may be another content.

The registration processing unit 102 may perform registration after searching whether the report information before registration overlaps with the existing report. For example, the registration processing unit 102 sends the position information included in the report information generated for registration to the search processing unit 101 to make a search with the position information as the search range.

(Display Processing Unit 103)

The display processing unit 103 receives an instruction for outputting various types of information from the search processing unit 101 or the registration processing unit 102, and outputs various types of information. For example, the display processing unit 103 displays a map and a search range in such a way as to be superimposed on the display device 20. The size (for example, radius) and position of the search range can be changed. The search range may be able to be intuitively selected by the administrator, such that the radius is changed each time the search range is clicked, for example. The display processing unit 103 transmits information on the set search range (for example, position information of Px on a map) to the search processing unit 101.

(Report Information Storage Unit 104)

The report information storage unit 104 stores report information indicating a report of road deterioration from road users such as residents. The storage unit stores report information in which report contents indicating the deterioration state of a road are associated with position information including at least one of the deterioration occurrence position indicating the specified position of occurrence of deterioration and the deterioration occurrence range indicating a predetermined range.

(Deterioration Information Storage Unit 105)

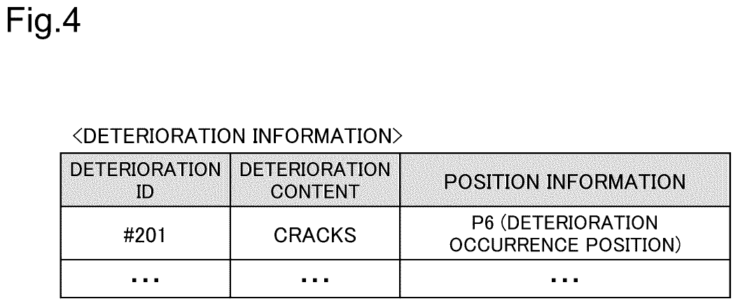

The deterioration information storage unit 105 stores deterioration information indicating the deterioration state of a road determined by the deterioration determination device 30. Referring to FIG. 4, the deterioration information includes items of deterioration ID, deterioration state, and position information. The deterioration ID is an identifier of deterioration information. The deterioration state indicates the deterioration state of a road. The deterioration state is a crack or a pot hole, for example. The deterioration state is not limited thereto, and may be another state. The position information in the deterioration information is a deterioration occurrence position where the occurrence position of road deterioration is specified. The deterioration occurrence position in the deterioration information may also be position information using base station positioning or GPS positioning or a distance from a reference point in a road section, for example.

(Operations)

Operations of the information management device 10 according to the first example embodiment will be described with reference to the drawings. The operations of the information management device 10 include search processing, registration processing, and update processing.

<Search Processing>

The search processing of the information management device 10 will be described. The search process is a process of searching report information registered in the information management device 10 based on a report of a road user such as a resident. The following search processing is an example of checking whether a report of road deterioration from a road user such as a resident overlaps with an existing report in the information management device 10, for example.

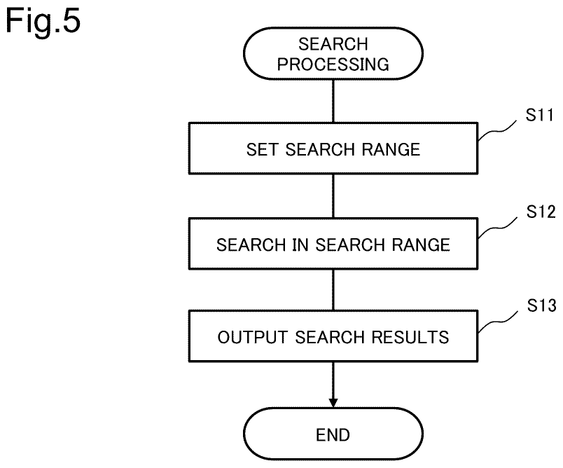

FIG. 5 is a flowchart illustrating an example of operations in the search processing. First, the administrator receives a report that “there is deterioration on a road near Px” from a road user such as a resident by telephone, inputs information of the temporary position Px to the information management device 10, and causes the display device 20 to display and output a map including the temporary position Px.

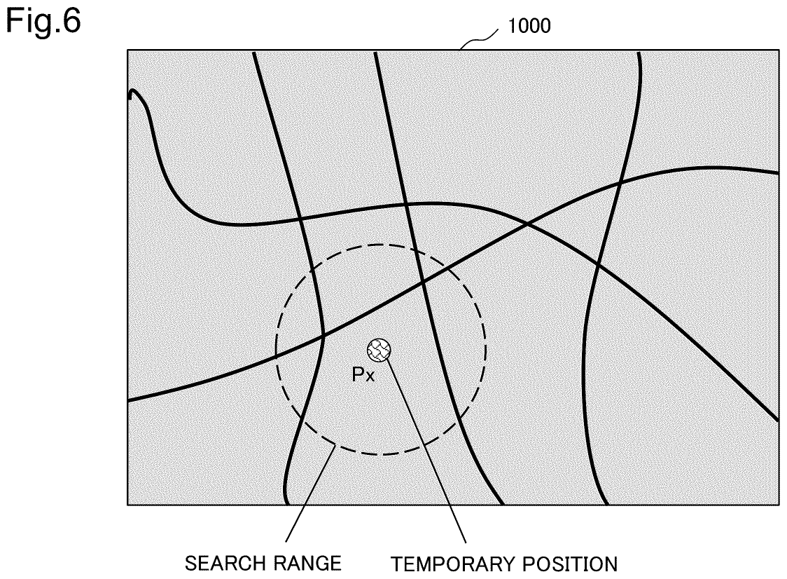

The display processing unit 103 sets a search range of the temporary position Px on the map based on the input from the administrator (step S11). FIG. 6 is a diagram illustrating an example of setting a search range near Px. As illustrated in a map display 1000 in FIG. 6, the search range is set by adjusting the search range (temporary position and deterioration occurrence range) of Px superimposed and displayed on the map with a mouse or the like. The display processing unit 103 extracts information on the search range based on the scale of the map to be displayed and the range of the radius centered on the temporary position Px. The setting of the search range is an example, and the present invention is not limited thereto.

When setting the search range, the administrator adjusts the temporary position of Px on the map and the radius of the deterioration occurrence range as appropriate according to the details of the report from a road user such as a resident. For example, in a case that the report from a road user such as a resident includes a detailed position, the radius is set to 50 m, and in a case that the report is not detailed, the radius is set to 100 m. The reference of the radius is an example, and the present invention is not limited thereto.

Returning to FIG. 5, the display processing unit 103 sends the information on the set search range to the search processing unit 101, and the search processing unit 101 receives the search range from the display processing unit 103. The search processing unit 101 refers to the report information in the report information storage unit 104 and searches for report information whose position information is included in the received search range (step S12).

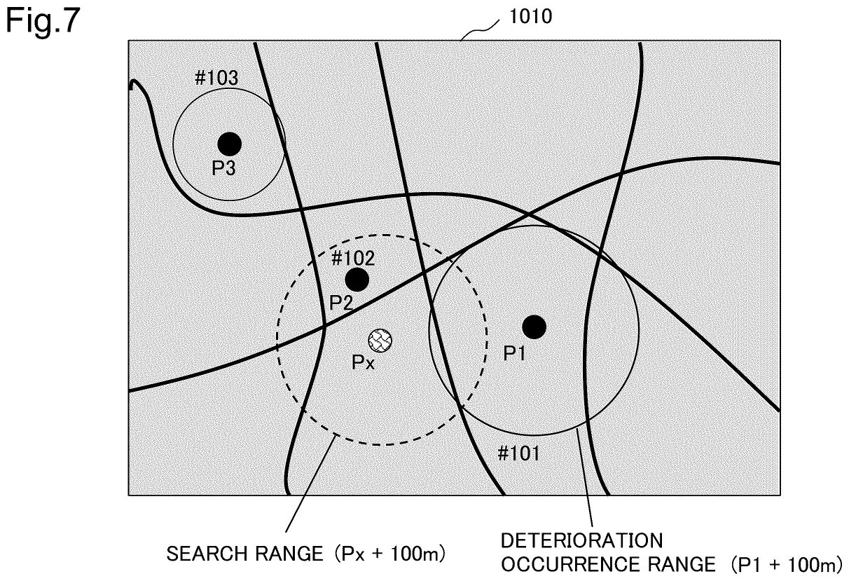

FIG. 7 is a diagram illustrating an example of a search range of Px and positions of existing report information. A map display 1010 illustrated in FIG. 7 indicates the positions of the existing reports of P1 with the report ID “#101”, P2 with the report ID “#102”, and P3 with the report ID “#103”, and the search range of Px. In the map display 1010 in FIG. 7, the search range of Px includes the deterioration occurrence range of P1 with the report ID “#101” and the deterioration occurrence position of P2 with the report ID “#102”.

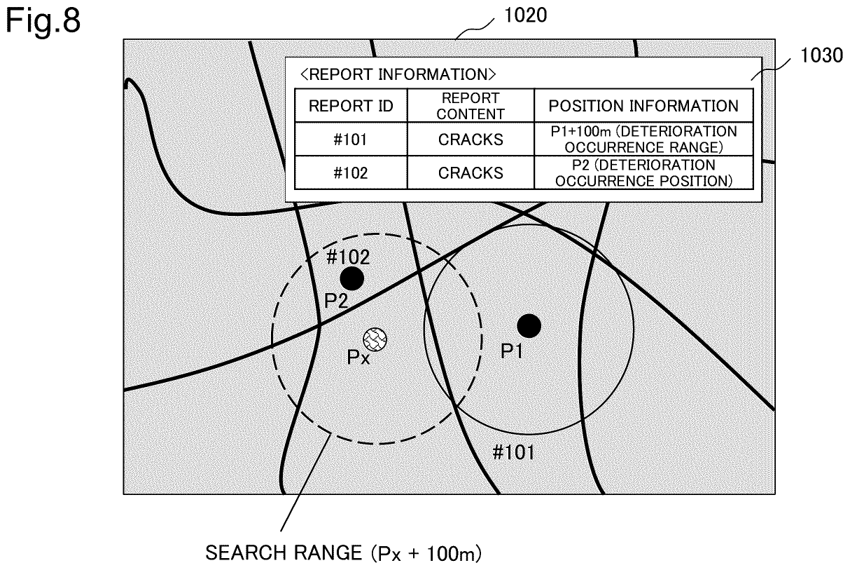

The search processing unit 101 transmits the search results to the display processing unit 103, and the display processing unit 103 outputs the search results (step S13). FIG. 8 is a diagram illustrating an example of a search results in the search range of Px. An example of the search results illustrated in FIG. 8 is a map display 1020 and search result data 1030. In the display of the search results as illustrated in FIG. 8, the search results may be ranked or filtered under a predetermined condition. The predetermined condition is a report date and time, report contents (by deterioration type), a distance from the search position (center position of the search range), and the like, for example.

In the search processing described above, the report ID “#101” and the report ID “#102” of the existing report information are output as the search results for the search range (Px+100 m) set by the administrator, based on the reports (near Px) of road deterioration from road users such as residents.

<Registration Processing>

The registration processing of the information management device 10 will be described. In the registration processing, the report information of the report information storage unit 104 is registered based on the received report. The following registration processing is an example in which the report information is registered after checking for an overlap between the report on road deterioration from road users such as residents and an existing report.

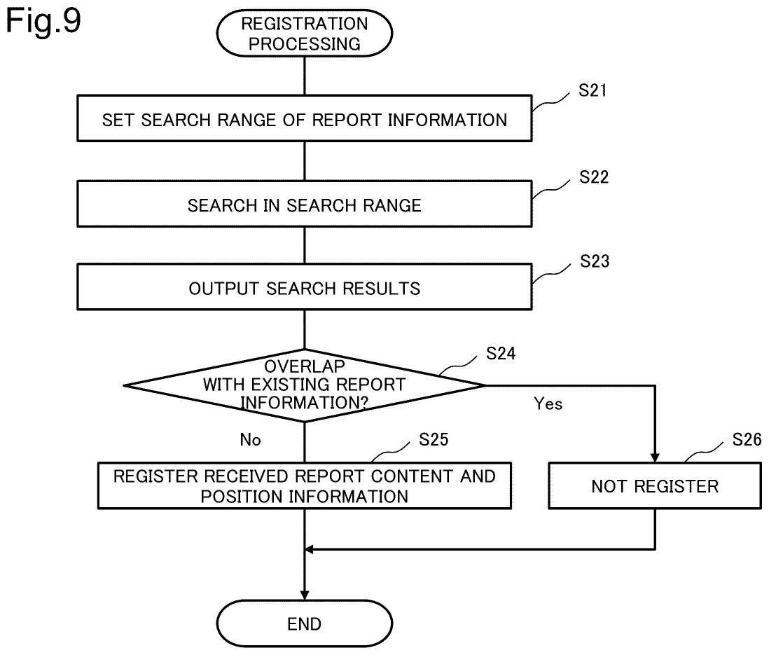

FIG. 9 is a flowchart illustrating an example of operations in the registration processing. The administrator receives a report that “there is a pot hole on the road near P4” from a road user such as a resident by telephone, inputs information on the position P4 to the information management device 10, and causes the display device 20 to display a map including the position P4.

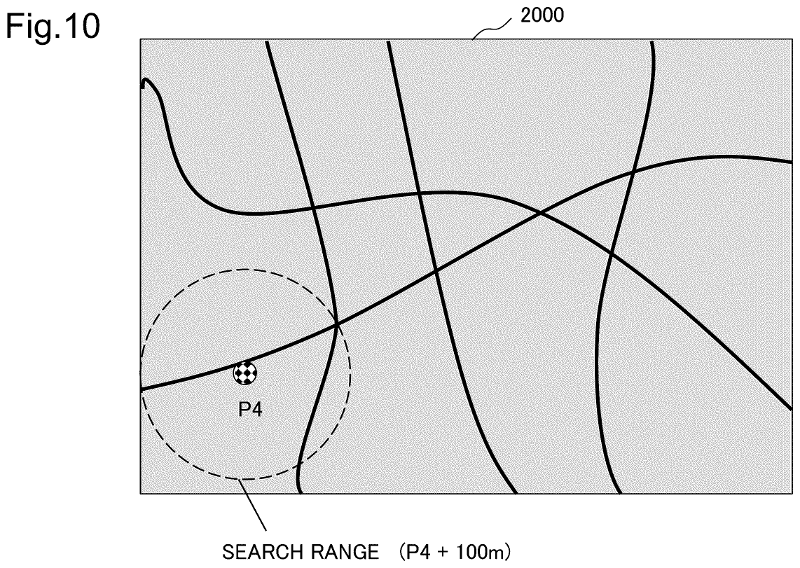

The display processing unit 103 sets the search range of the position P4 on the map based on the input from the administrator (step S21). FIG. 10 is a diagram illustrating an example of setting a search range near P4 in the report. The search range is set by adjusting the search range (temporary position and deterioration occurrence range) of P4 superimposed and displayed on the map with a mouse or the like.

Returning to FIG. 9, the display processing unit 103 sends the information on the set search range to the search processing unit 101, and the search processing unit 101 receives the search range from the display processing unit 103. The search processing unit 101 refers to the report information in the report information storage unit 104 and searches for report information whose position information is included in the received search range (step S22).

The search processing unit 101 passes the search results to the registration processing unit 102 and the display processing unit 103. The display processing unit 103 displays and outputs the search results to check for overlap with the existing report information (step S23).

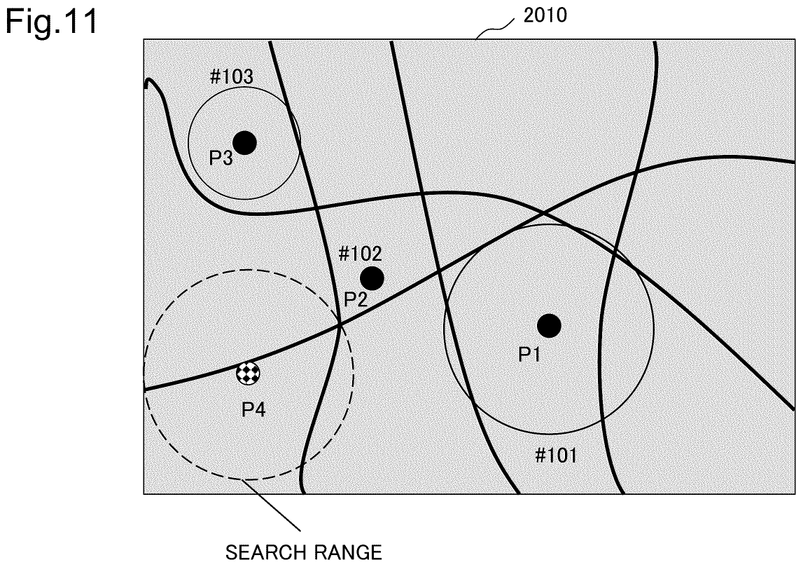

FIG. 11 is a diagram illustrating an example of a search range of P4 and positions of existing report information. A map display 2010 illustrated in FIG. 11 indicates the positions of P1 with the report ID “#101”, P2 with the report ID “#102”, and P3 with the report ID “#103”, and the search range of P4. In the map display 2010, there is no position information on the existing report information included in the search range of P4.

When the position information in the existing report does not overlap the search range (No in step S20), the registration processing unit 102 generates a report ID and registers the generated report ID, the report contents of the received report, and the position information (deterioration occurrence range) in the report information storage unit 104 in association with each other (step S25).

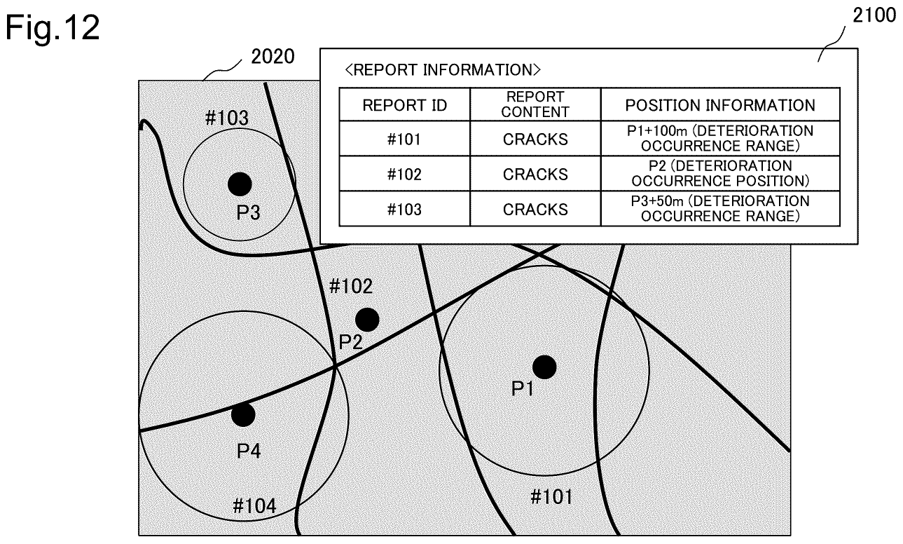

FIG. 12 is a diagram illustrating an example of report information in which the report of P4 is registered. As illustrated in data 2100 of the report information of FIG. 12, the report ID “#104”, the report content “pot hole”, and the position information “P4+100 m (deterioration occurrence range)” are newly registered in the report information storage unit 104.

In a map display 2020 of FIG. 12, in addition to P1 with the report ID “#101”, P2 with the report ID “#102”, and P3 with the report ID “#103”, the deterioration occurrence range of P4 with the report ID “#104” is added.

On the other hand, in a case that the position information in the existing report overlaps the search range, the registration processing unit 102 does not register the received report (step S26). Checking for overlapping reports in the search eliminates the need to manage a large number of pieces of report information on the deterioration state of the same portion on the road, thereby reducing the burden of management.

For the above-described registration processing, an example has been described in which the report information is registered after checking for an overlap between the report on road deterioration from road users such as residents and an existing report. Besides, the registration processing unit 102 may generate and register report information on a report of road deterioration from road users such as residents without checking for an overlap with an existing report. For example, after checking for an overlap, the registration processing unit 102 may present check results to the administrator, and accept final determination from the administrator as to whether to register the report information.

When the occurrence position of road deterioration in the report information is specified by confirmation work or the like, the deterioration occurrence range is updated to the deterioration occurrence position by update processing described later.

<Update Process>

An update processing of the information management device 10 will be described. The update processing is a process of updating position information (deterioration occurrence range) in report information based on a confirmation report from a person in charge who has confirmed the occurrence position of road deterioration on site. For example, the person in charge makes the confirmation report using the first communication terminal 40. The confirmation report includes a report content and a confirmed position. The report content is a content related to road deterioration reported from a person in charge who has checked the site. The confirmed position indicates a position where the occurrence position of road deterioration has been confirmed. The deterioration occurrence position may be position information using base station positioning or global positioning system (GPS) positioning, or may be a position information at a distance from a reference point in a road section, for example.

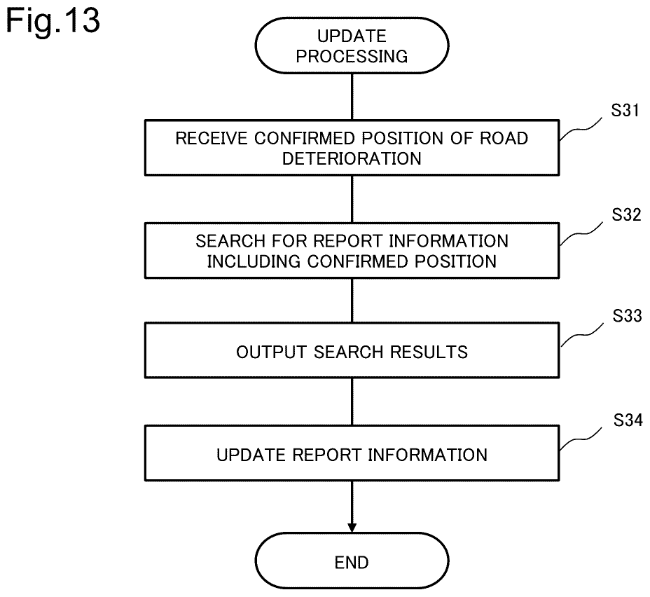

FIG. 13 is a flowchart illustrating an example of operations in the update processing. The administrator receives the confirmation report from the person in charge, and inputs the position information of the confirmed position P100 to the information management device 10. The registration processing unit 102 receives the confirmed position of road deterioration (step S31). After receiving the confirmed position, the registration processing unit 102 sends the confirmed position to the search processing unit 101. The search processing unit 101 searches for the report information including the deterioration occurrence range of the existing report with respect to the confirmed position in the confirmation report (step S32). The search processing unit 101 transmits the search results of the confirmed position to the display processing unit 103, and the display processing unit 103 outputs the search results (step S33).

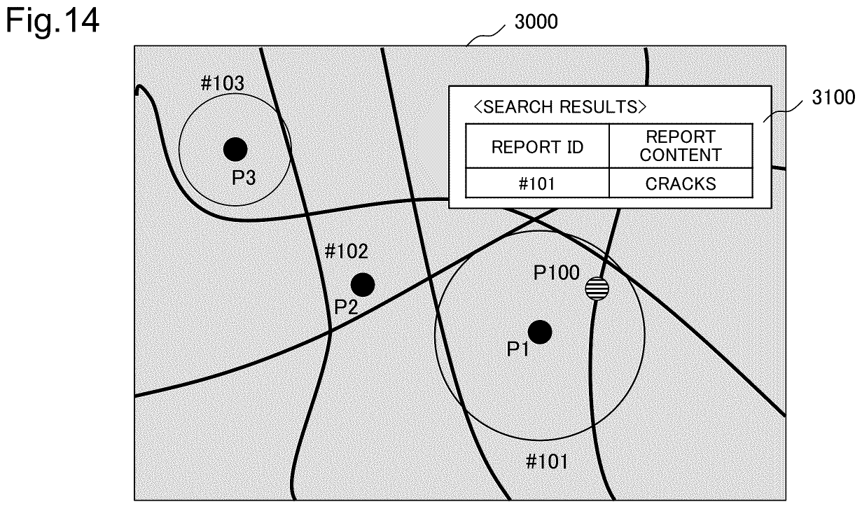

FIG. 14 is a diagram illustrating a confirmed position P100 and a position in existing report information. A map display 3000 displays a deterioration occurrence range of P1 with the existing report ID “#101”, a position of P2 with the report ID “#102”, a deterioration occurrence range of P3 with the report ID “#103”, and the position of P100 in the confirmation report. A display 3100 includes search result data. From the search results, the report information including the confirmed position P100 in the confirmation report in the deterioration occurrence range is P1 with “#101”.

From the search result, the administrator selects whether to update the deterioration occurrence range of P1 with the report ID “#101” which is the existing report information to the confirmed position P100 in the confirmation report. When the administrator inputs the selection of the update and the registration processing unit 102 receives the selection input, the registration processing unit 102 updates the report information (step S34). Through the update processing, the registration processing unit 102 updates the report information in the report information storage unit 104 (step S34).

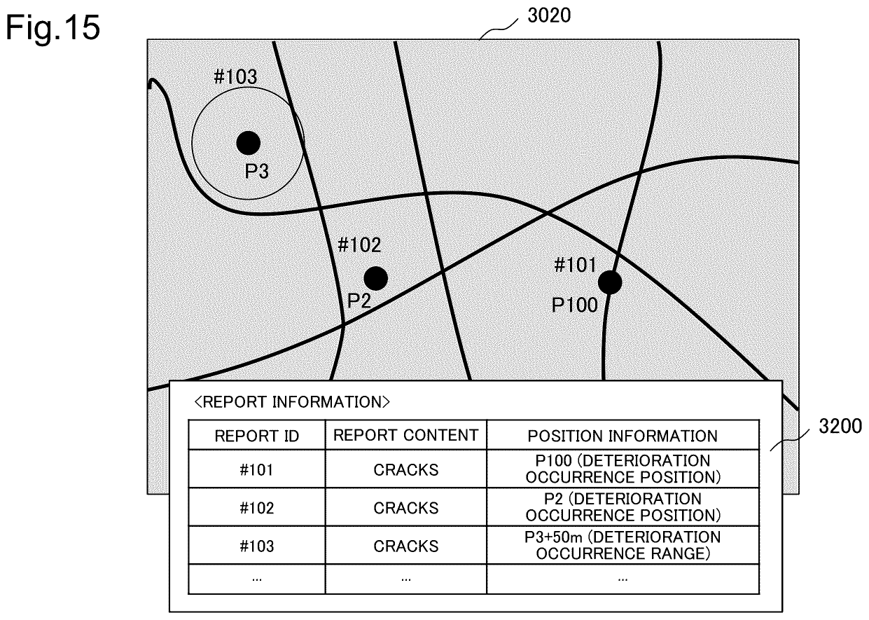

FIG. 15 is a diagram illustrating an example of the updated report information. A map display 3020 displays the position P2 with the existing report ID “#102”, the deterioration occurrence range P3 with the report ID “#103”, and the updated position P100 of the report ID “#101”. A display 3200 includes data indicating the updated report information, and the position information with the report ID “#101” is updated to “P100 (deterioration occurrence position)”. In the above description, the position information is updated by the confirmation report. However, the registration processing unit 102 may update the report contents included in the report information based on the report contents of the confirmation report. For example, the report contents may be changed from “crack” to “pot hole”.

<Other Registration Processing>

Another registration processing of the information management device 10 will be described. The following registration processing is a process that is performed by a road user such as a resident registering report information of road deterioration in the report information storage unit 104 using the second communication terminal 50.

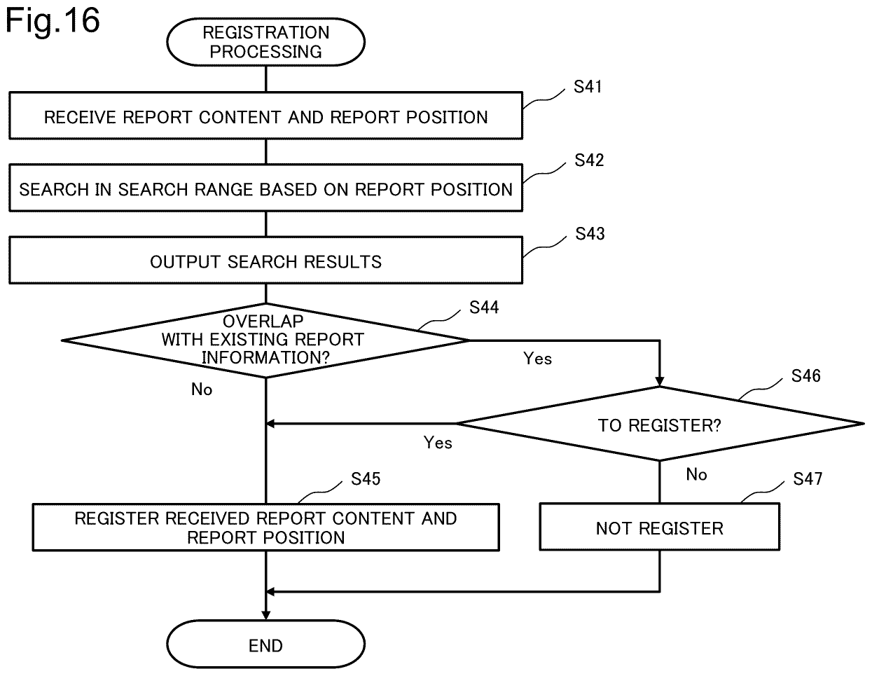

FIG. 16 is a flowchart illustrating another example of operations in the registration processing. When finding road deterioration, a road user such as a resident executes an application on the second communication terminal 50 and communicably connects to the information management device 10. The application may be a browser application, for example. Hereinafter, road deterioration found by the road user such as a resident will be described as “cracks near P5”.

The information management device 10 receives the report content and the report position from the second communication terminal 50 operated by the road user such as a resident (step S41). The display processing unit 103 of the information management device 10 transmits map information including the report position P5 to the second communication terminal, and displays the map information and the search range of P5. The road user such as a resident adjusts the search range 5 on the screen of the second communication terminal 50, and transmits the search range of P5 based on the report position from the second communication terminal 50 to the information management device 10.

Returning to FIG. 16, the display processing unit 103 of the information management device 10 sends the information of the search range based on the report position to the search processing unit 101, and the search processing unit 101 receives the search range from the display processing unit 103. The search processing unit 101 refers to the report information in the report information storage unit 104 and searches for report information whose position information is included in the received search range (step S42).

The search processing unit 101 passes the search results to the registration processing unit 102 and the display processing unit 103. The display processing unit 103 outputs the search results to check for overlap with the existing report information (step S43).

If there is no overlap with the existing report information (No in step 44), the registration processing unit 102 stores report information in which the received report content of P5 and the position information of the report position are associated with each other in the report information storage unit 104 (step S45).

If there is an overlap with the existing report information (Yes in step 44), the registration processing unit 102 instructs the display processing unit 103 to output data 4100 of the report information reported by the road user such as a resident and data 4200 as the search results of the existing report information, and causes the second communication terminal 50 of the road user such as a resident to display the data.

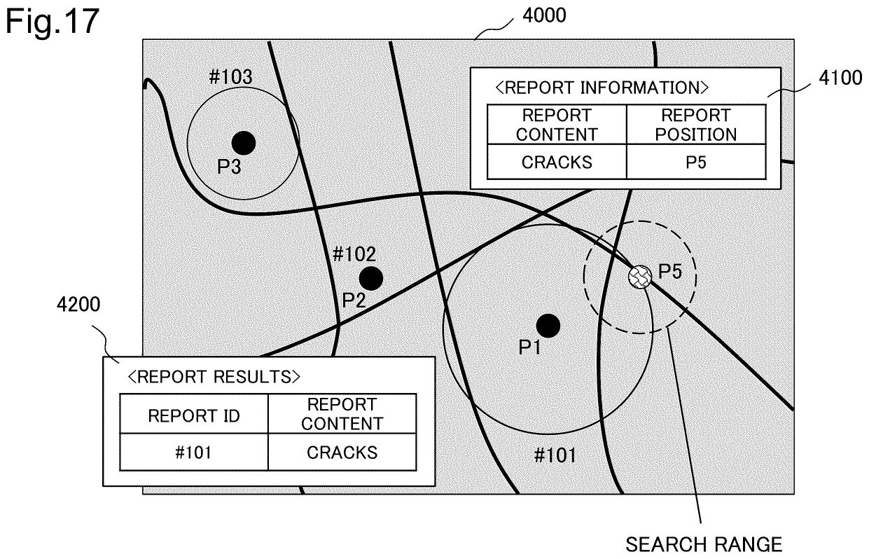

FIG. 17 is a diagram illustrating an example of a search range of P5 and a position of existing report information. A map display 4000 illustrated in FIG. 17 indicates the positions of P1 with the report ID “#101”, P2 with the report ID “#102”, and P3 with the report ID “#103”, and the search range of P5. In the map display 4000, the existing report information included in the search range of P5 is the deterioration occurrence range of P1 with the report ID “#101”. The registration processing unit 102 further instructs the display processing unit 103 to display the registration confirmation of selecting “Register” or “Not register” for the reported P5 on the second communication terminal 50.

When the selection input from the second communication terminal 50 is “Not register” (No in step S46), the registration processing unit 102 ends the registration processing. When the selected input is “Register”, the registration processing unit 102 generates a report ID and stores report information in which the received report content of P5 and the position information of the report position are associated with each other in the report information storage unit 104 (step S45).

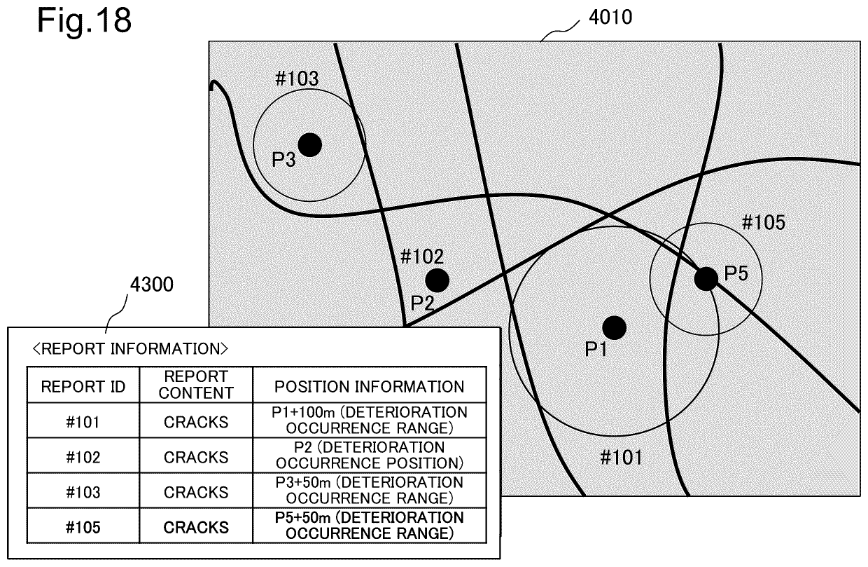

FIG. 18 is a diagram illustrating an example of report information in which the report of P5 is registered. As illustrated in data 4300 of the report information in FIG. 18, the report ID “#105”, the report content “cracks”, and the position information “P5+50 m (deterioration occurrence range)” are newly registered in the report information storage unit 104.

In a map display 4010 of FIG. 18, in addition to P1 with the report ID “#101”, P2 with the report ID “#102”, and P3 with the report ID “#103”, the deterioration occurrence range of P5 with the report ID “#105” is added.

<Search Processing Including Deterioration Information>

Another example of the search processing of the information management device 10 will be described. The following search processing is an example of searching the report information and deterioration information registered in the information management device 10 based on a report from a road user such as a resident.

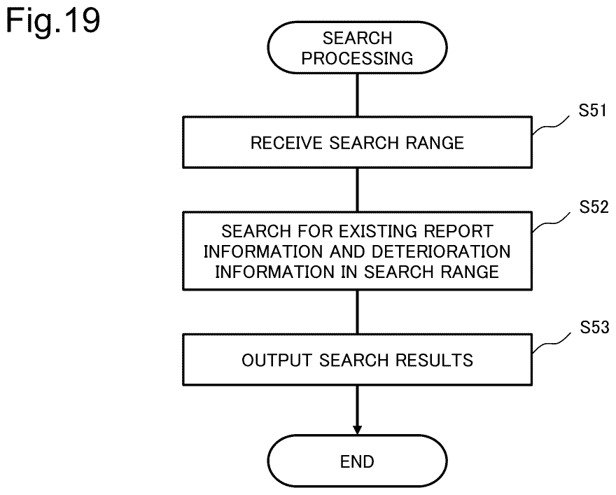

FIG. 19 is a flowchart illustrating an example of operations in the search processing. A report of road deterioration from a road user such as a resident will be described as “There is deterioration on a road near Px”.

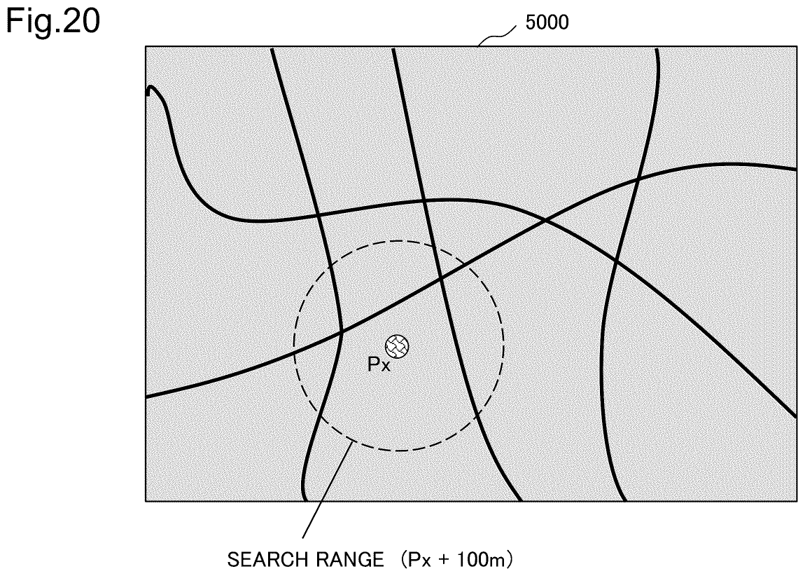

The display processing unit 103 of the information management device 10 sets the search range of the temporary position Px on the map based on the input from the administrator. FIG. 20 is a diagram illustrating an example of setting a search range near Px. As illustrated in a map display 5000 in FIG. 20, the search range is set by adjusting the search range (temporary position and deterioration occurrence range) of Px superimposed and displayed on the map with a mouse or the like.

Returning to FIG. 19, the display processing unit 103 sends the information on the set search range to the search processing unit 101, and the search processing unit 101 receives the search range from the display processing unit 103 (step S51). The search processing unit 101 refers to the report information in the report information storage unit 104 and the deterioration information in the deterioration information storage unit 105, and searches for report information whose position information is included in the received search range (step S52).

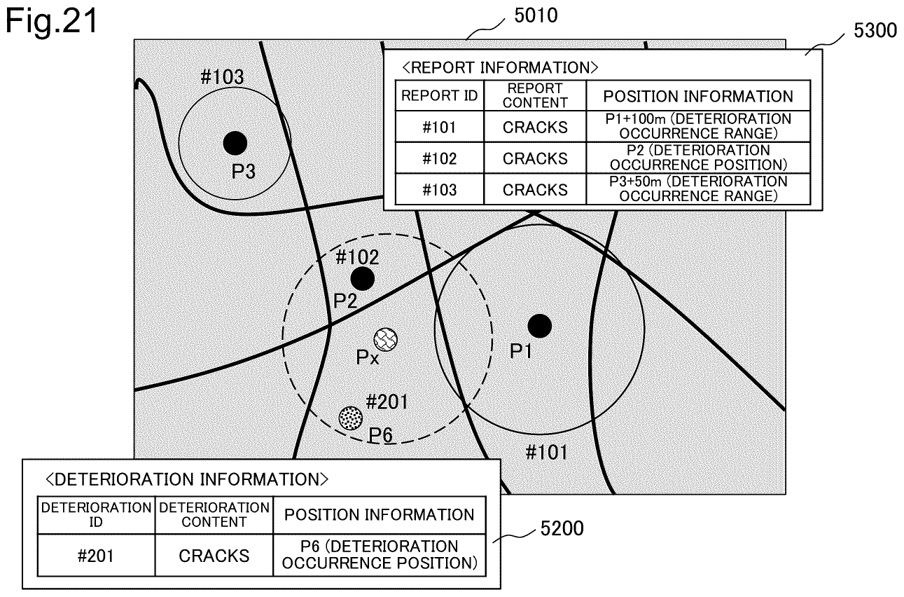

FIG. 21 is a diagram illustrating an example of a search range of Px and a position of existing report information and deterioration information. A map display 5010 illustrated in FIG. 21 indicates the positions of the existing reports of P1 with the report ID “#101”, P2 with the report ID “#102”, and P3 with the report ID “#103”, P6 with the deterioration ID “#201”, and the search range of Px. In the map display 5010 in FIG. 21, the search range of Px includes the deterioration occurrence range of P1 with the report ID “#101”, the deterioration occurrence position of P2 with the report ID “#102”, and P6 with the deterioration ID “#201”.

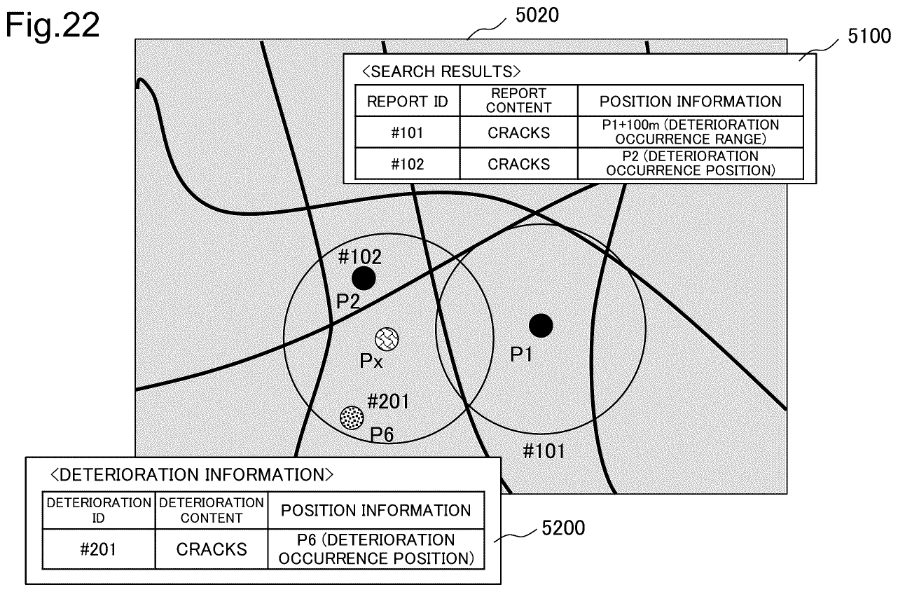

Returning to FIG. 19, the search processing unit 101 transmits the search results to the display processing unit 103, and the display processing unit 103 outputs the search results (step S53). FIG. 22 is a diagram illustrating an example of search results obtained by searching the existing report information and deterioration information. Search results 5100 are results of searching the report information in the report information storage unit 104. Search results 5200 are results of searching the deterioration information in the deterioration information storage unit 105. A map display 5020 indicates existing report information and deterioration information searched in the search range of Px in which road users such as residents have reported road deterioration. On the map, the search range of Px includes P1 with the report ID “#101”, P2 with the report ID “#102”, and P6 with the deterioration ID “#201”.

In the display of the search results as illustrated in FIG. 21, the search results may be ranked or filtered under a predetermined condition. The predetermined condition is a report date and time, report contents (by deterioration type), a distance from the search position (center position of the search range), and the like, for example.

Displaying the deterioration information determined based on the sensor information in addition to the report information from the road users such as the residents by the search processing including the deterioration information makes it possible to easily compare which deterioration information the report information corresponds to.

(Effects of First Example Embodiment)

According to the information management device 10 of the first example embodiment, it is possible to efficiently manage reports on road deterioration from road users such as residents in road deterioration management. The reason is that the report information storage unit 104 stores report information indicating reports on road deterioration, and each report information includes a rough position (deterioration occurrence range) as the occurrence position of the road deterioration. Then, the search processing unit 101 sets a rough position (deterioration occurrence range) and searches the report information in the report information storage unit 104.

### Second Example Embodiment

An information management device according to a second example embodiment will be described with reference to the drawings. An information management device 11 according to the second example embodiment is communicably connected to a first communication terminal 40 and a second communication terminal 50 via a network 60, as with the information management device 10 according to the first example embodiment. The information management device 11 is connected to a display device 20 and a deterioration determination device 30.

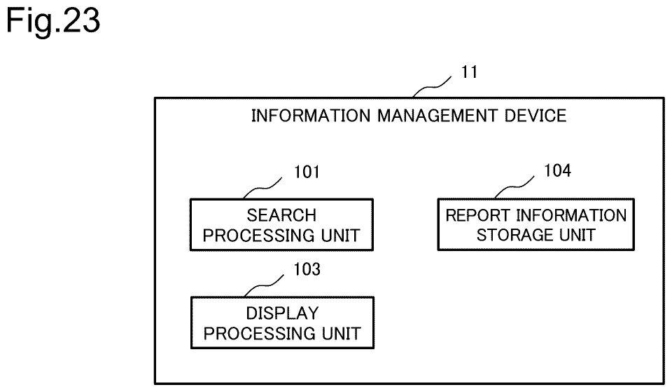

FIG. 23 is a block diagram illustrating an example of a configuration of the information management device 11. The information management device 11 includes a search processing unit 101, a display processing unit 103, and a report information storage unit 104. The configuration of the information management device 11 according to the second example embodiment is a configuration in which the registration processing unit 102 and the deterioration information storage unit 105 are eliminated from the information management device 10 according to the first example embodiment.

The search processing unit 101 receives a search range and refers to the report information in the report information storage unit 104 to search the report information including the position information in the received search range.

The display processing unit 103 receives an instruction for outputting various types of information from the search processing unit 101, and outputs various types of information. For example, the display processing unit 103 displays and outputs the search results from the search processing unit 101. The display processing unit 103 may also display a map and the search range in a superimposed manner on the display device 20 in order to set the search range before the search.

The report information storage unit 104 stores report information indicating a report of road deterioration from road users such as residents. In the report information, a report ID, report content, and location information are stored in association with each other. The report information may include other items.

The report ID is an identifier of the report information. The report content is a content related to road deterioration reported from road users such as residents. The position information indicates the occurrence position of road deterioration. The position information includes a deterioration occurrence position and a deterioration occurrence range. The deterioration occurrence position indicates the position where the occurrence position of road deterioration is specified by road confirmation work or the like. The deterioration occurrence range indicates the rough range of an occurrence position of road deterioration. For example, the deterioration occurrence range is indicated by a range at a predetermined distance from the temporary position.

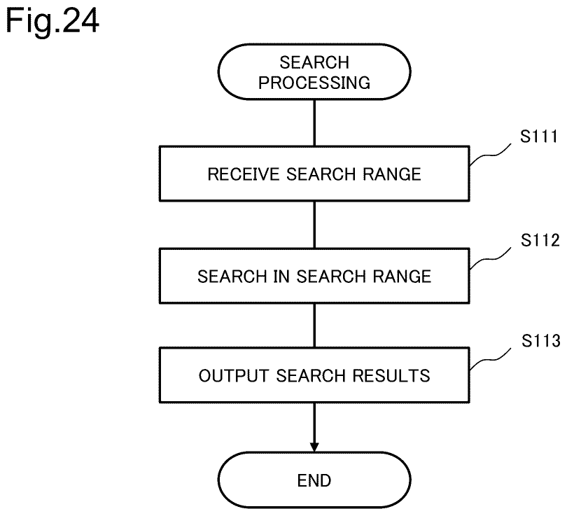

FIG. 24 is a flowchart illustrating an example of operations of the information management device 11 according to the second example embodiment.

FIG. 24 is a flowchart illustrating an example of operations in the search processing. The display processing unit 103 sets the search range based on the input from the administrator. For example, the search range is a range having a radius of 100 m centered on the temporary position. The search range is not limited to this example.

The search processing unit 101 receives the search range (step S111), refers to the report information in the report information storage unit 104, and searches for the report information in which the position information (the deterioration occurrence position or the deterioration occurrence range) is included in the received search range (step S112). The search processing unit 101 transmits the search results to the display processing unit 103. The display processing unit 103 outputs the search results from the search processing unit 101 (step S113).

(Effects of Second Example Embodiment)

According to the information management device 11 of the second example embodiment, it is possible to efficiently manage reports on road deterioration from road users such as residents in road deterioration management. The reason is that the report information storage unit 104 stores report information indicating reports on road deterioration, and each report information includes a rough position (deterioration occurrence range) as the occurrence position of the road deterioration. This is because the search processing unit 101 searches the report information in the report information storage unit 104 by a rough position (search range).

(Hardware Configuration)

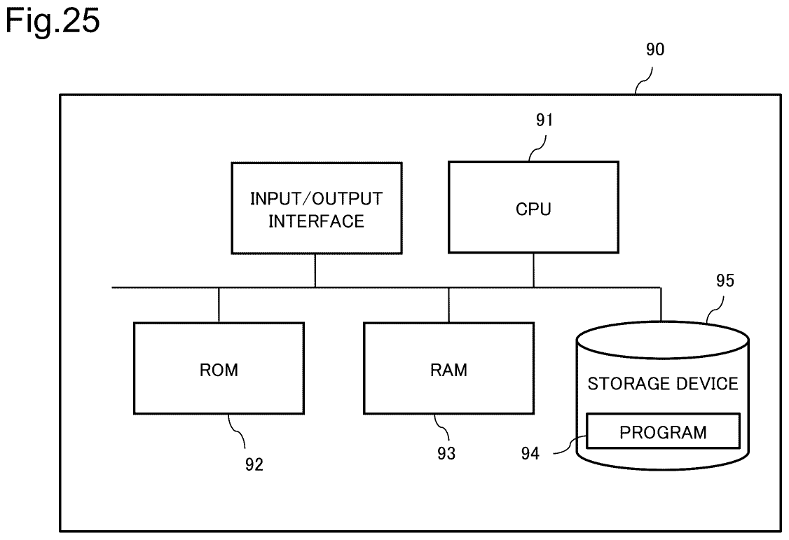

FIG. 25 is a diagram illustrating an example of a hardware configuration of a computer. The information management devices 10 and 11, the deterioration determination device 30, the first communication terminal 40, and the second communication terminal 50 described above are implemented by executing programs (software programs or computer program) in a central processing unit (CPU) 91 of a computer 90 illustrated in FIG. 25. Specifically, the functions of the search processing unit 101, the registration processing unit 102, and the display processing unit 103 of the information management device 10 are implemented by executing the programs. Any of the functions of the search processing unit 101, the registration processing unit 102, and the display processing unit 103 may be configured by an external device (not illustrated), and the function may be provided from the external device to the information management device 10 via the network 60. The configuration of the information management device 10 may be implemented by the CPU 91 reading a program 94 from a read only memory (ROM) 92 or a storage device 95 and executing the read program 94 using the CPU 91 and a random access memory (RAM) 93. The present disclosure described using the example embodiments as examples can be regarded as being configured by a code representing a computer program or a computer-readable storage medium in which the code representing the computer program is stored. The computer-readable storage medium is the storage device 95, a removable magnetic disk medium (not illustrated), an optical disk medium, a memory card, or the like, for example. The configuration of each example embodiment may be dedicated hardware by an integrated circuit. The information management devices 10 and 11 and the deterioration determination device 30 may be configured by cloud computers.

The present disclosure is not limited to the above-described example embodiments, and various modifications can be made, and example embodiments obtained by appropriately combining configurations, operations, and processes disclosed in different example embodiments are also included in the technical scope of the present disclosure.

The present disclosure is not limited to the above-described example embodiments. That is, the present invention can apply to various aspects that can be understood by those skilled in the art within the scope of the present invention.

[Supplementary Notes]

[Supplementary Note 1]

An information management device including
a storage means that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area,
a search processing means that searches the storage means for report information in which the position information is included in a search range indicating a predetermined range to be searched, and
a display processing means that outputs a search result.

[Supplementary Note 2]

The information management device according to Supplementary Note 1, wherein
the search processing means searches the storage means for the report information in which the position information is included at a search position indicating a specific position to be searched.

[Supplementary Note 3]

The information management device according to Supplementary Note 1 or 2, further including
a registration processing means that registers, in the storage means, the report information in which the report content is associated with the position information including the deterioration occurrence position or the deterioration occurrence range, in response to an input from a user.

[Supplementary Note 4]

The information management device according to Supplementary Note 3, wherein
the registration processing means registers the report information in a case that the report information and existing report information do not overlap each other.

[Supplementary Note 5]

The information management device according to any one of Supplementary Notes 1 to 4, wherein
the storage means stores deterioration information in which a deterioration content indicating a deterioration state of a road determined based on sensor information is associated with an occurrence position of the deterioration content.

[Supplementary Note 6]

The information management device according to Supplementary Note 5, wherein
the display processing means displays the deterioration information in addition to the report information as the search result from the search processing means.

[Supplementary Note 7]

The information management device according to Supplementary Note 3 or 4, wherein
the search processing means searches the report information in which a confirmed position included in a confirmation report of road deterioration is included in the deterioration occurrence range, and the registration processing means receives an input of selection of report information corresponding to the confirmation report from the searched report information, and updates position information in the selected report information with the confirmed position included in the confirmation result as the deterioration occurrence position.

[Supplementary Note 8]

An information management method including
searching a storage means that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area, for report information in which the position information is included in a search range indicating a predetermined range to be searched, and
outputting a search result.

[Supplementary Note 9]

A storage medium storing a program for causing a computer to execute
searching a storage means that stores report information in which a report content and position information are associated with each other, the report content indicating a deterioration condition of a road, and the position information including at least any of a deterioration occurrence position indicating a position specified for occurrence of deterioration and a deterioration occurrence range indicating a predetermined area, for report information in which the position information is included in a search range indicating a predetermined range to be searched, and
outputting a search result.

### REFERENCE SIGNS LIST

10, 11 Information management device
20 Display device
30 Deterioration determination device
40 First communication terminal
50 Second communication terminal
101 Search processing unit
102 Registration processing unit
103 Display processing unit
104 Report information storage unit
105 Deterioration information storage unit

What is claimed is:

1. An information management device comprising:
at least one memory storing instructions; and
at least one processor configured to access the at least one memory and execute the instructions to:
store, in a storage, report information including a report content and position information associated with each other, the report content indicating a deterioration condition of a road, and the position information including at least any of a deterioration occurrence position indicating a position specified for occurrence of deterioration and a deterioration occurrence range indicating a predetermined area;
search the storage for report information including the position information in a search range, the search range indicating a predetermined range to be searched; and
generate an output based on the searched report information.

2. The information management device according to claim 1, wherein
the at least one processor is further configured to execute the instructions to:
search the storage for the report information including the position information at a search position, the search position indicating a specific position to be searched.

3. The information management device according to claim 1, wherein
the at least one processor is further configured to execute the instructions to:
register, in the storage, the report information including the report content is associated with the position information including the deterioration occurrence position or the deterioration occurrence range, in response to an input from a user.

4. The information management device according to claim 3, wherein
the at least one processor is further configured to execute the instructions to:
register the report information in a case that the report information and existing report information do not overlap each other.

5. The information management device according to claim 1, wherein
the at least one processor is further configured to execute the instructions to:
store deterioration information including a deterioration content and an occurrence position of the deterioration content associated with each other, the deterioration content indicating a deterioration state of a road determined based on sensor information.

6. The information management device according to claim 5, wherein
the at least one processor is further configured to execute the instructions to:
generate the output based on the deterioration information in addition to the searched report information.

7. The information management device according to claim 3, wherein
the at least one processor is further configured to execute the instructions to:
search the report information including a confirmed position in the deterioration occurrence range, the confirmed position included in a confirmation report of road deterioration;
receive an input of selection of report information corresponding to the confirmation report from the searched report information; and
update position information in the selected report information with the confirmed position as the deterioration occurrence position.

8. An information management method comprising:
storing, in a storage, report information including a report content and position information associated with each other, the report content indicating a deterioration condition of a road, and the position information including at least any of a deterioration occurrence position indicating a position specified for occurrence of deterioration and a deterioration occurrence range indicating a predetermined area,
searching the storage for report information including the position information in a search range, the search range indicating a predetermined range to be searched, and
generating an output based on the searched report information.

9. A non-transitory storage medium storing a program for causing a computer to execute:
storing, in a storage, report information including a report content and position information associated with each other, the report content indicating a deterioration condition of a road, and the position information including at least any of a deterioration occurrence position indicating a position specified for occurrence of deterioration and a deterioration occurrence range indicating a predetermined area,
searching the storage for report information including the position information in a search range, the search range indicating a predetermined range to be searched, and
generating an output based on the searched report information.

10. The information management method according to claim 8, further comprising:
searching the storage for the report information including the position information at a search position, the search position indicating a specific position to be searched.

11. The information management method according to claim 8, further comprising:
registering, in the storage, the report information including the report content is associated with the position information including the deterioration occurrence position or the deterioration occurrence range, in response to an input from a user.

12. The information management method according to claim 11, further comprising:
registering the report information in a case that the report information and existing report information do not overlap each other.

13. The information management method according to claim 8, further comprising:
storing deterioration information including a deterioration content and an occurrence position of the deterioration content associated with each other, the deterioration content indicating a deterioration state of a road determined based on sensor information.

14. The information management device according to claim 13, further comprising:
generating the output based on the deterioration information in addition to the searched report information.

15. The information management method according to claim 11, further comprising:
searching the report information including a confirmed position in the deterioration occurrence range, the confirmed position included in a confirmation report of road deterioration;
receiving an input of selection of report information corresponding to the confirmation report from the searched report information; and
updating position information in the selected report information with the confirmed position as the deterioration occurrence position.

16. The non-transitory recording medium storing the program that causes the computer to perform the processing according to claim 9, the processing further comprising:
searching the storage for the report information including the position information at a search position, the search position indicating a specific position to be searched.

17. The non-transitory recording medium storing the program that causes the computer to perform the processing according to claim 9, the processing further comprising:
registering, in the storage, the report information including the report content is associated with the position information including the deterioration occurrence position or the deterioration occurrence range, in response to an input from a user.

18. The non-transitory recording medium storing the program that causes the computer to perform the processing according to claim 17, the processing further comprising:
registering the report information in a case that the report information and existing report information do not overlap each other.

19. The non-transitory recording medium storing the program that causes the computer to perform the processing according to claim 9, the processing further comprising:
storing deterioration information including a deterioration content and an occurrence position of the deterioration content associated with each other, the deterioration content indicating a deterioration state of a road determined based on sensor information.

20. The non-transitory recording medium storing the program that causes the computer to perform the processing according to claim 19, the processing further comprising:
generating the output based on the deterioration information in addition to the searched report information.
